(19) United States
(12) Patent Application Publication
(10) Pub. No.: US 2015/0064591 A1
(43) Pub. Date: Mar. 5, 2015

(54) HEATER AND METHOD OF OPERATING

(71) Applicant: DELPHI TECHNOLOGIES, INC., Troy, MI (US)

(72) Inventors: KARL J. HALTINER, JR., FAIRPORT, NY (US); MARK A. WIRTH, GRAND BLANC, MI (US)

(21) Appl. No.: 14/013,879

(22) Filed: Aug. 29, 2013

(51) Int. Cl. E21B 36/00; H01M 8/04

(52) U.S. Cl. CPC E21B 36/008; H01M 8/04037
USPC 429/435; 429/434; 166/57; 166/58

(57) ABSTRACT

A heater includes a heater housing extending along a heater axis. A fuel cell stack assembly is disposed within the heater housing and includes a plurality of fuel cells which convert chemical energy from a fuel into heat and electricity through a chemical reaction with an oxidizing agent. An electric resistive heating element is disposed within the heater housing. A positive conductor is disposed within the heater housing and is connected to the fuel cell stack assembly and to the electric resistive heating element and a negative conductor is connected to the fuel cell stack assembly and to the electric resistive heating element. The electric resistive heating element is arranged to elevate the fuel cell stack assembly from a first inactive temperature to a second active temperature.

### TECHNICAL FIELD OF INVENTION

The present invention relates to a heater which uses fuel cell stack assemblies as a source of heat; more particularly to such a heater which is positioned within a bore hole of an oil containing geological formation in order to liberate oil therefrom; and even more particularly to such a heater which includes electric resistive heating elements to start operation of the fuel cell stack assemblies.

### BACKGROUND OF INVENTION

Subterranean heaters have been used to heat subterranean geological formations in oil production, remediation of contaminated soils, accelerating digestion of landfills, thawing of permafrost, gasification of coal, as well as other uses. Some examples of subterranean heater arrangements include placing and operating electrical resistance heaters, microwave electrodes, gas-fired heaters or catalytic heaters in a bore hole of the formation to be heated. Other examples of subterranean heater arrangements include circulating hot gases or liquids through the formation to be heated, whereby the hot gases or liquids have been heated by a burner located on the surface of the earth. While these examples may be effective for heating the subterranean geological formation, they may be energy intensive to operate.

U.S. Pat. Nos. 6,684,948 and 7,182,132 propose subterranean heaters which use fuel cells as a more energy efficient source of heat. The fuel cells are disposed in a heater housing which is positioned within the bore hole of the formation to be heated. The fuel cells convert chemical energy from a fuel into heat and electricity through a chemical reaction with an oxidizing agent. U.S. Pat. No. 7,182,132 teaches that in order to start operation of the heater, an electric current may be passed through the fuel cells in order to elevate the temperature of the fuel cells sufficiently high to allow the fuel cells to operate, i.e. an electric current is passed through the fuel cells before the fuel cells are electrically active. While passing an electric current through the fuel cells may elevate the temperature of the fuel cells, passing an electric current through the fuel cells before the fuel cells are electrically active may be harsh on the fuel cells and may lead to a decreased operational life thereof.

What is needed is a heater which minimizes or eliminates one of more of the shortcomings as set forth above.

### SUMMARY OF THE INVENTION

A heater includes a heater housing extending along a heater axis. A fuel cell stack assembly is disposed within the heater housing and includes a plurality of fuel cells which convert chemical energy from a fuel into heat and electricity through a chemical reaction with an oxidizing agent. An electric resistive heating element is disposed within the heater housing. A positive conductor is disposed within the heater housing and is connected to the fuel cell stack assembly and to the electric resistive heating element and a negative conductor is connected to the fuel cell stack assembly and to the electric resistive heating element. The electric resistive heating element is arranged to elevate the fuel cell stack assembly from a first inactive temperature to a second active temperature. In this way, the positive conductor and the negative conductor may service both the fuel cell stack assembly and the electric resistive heating element, thereby eliminating the need for separate conductors for the fuel cell stack assembly and the electric resistive heating element

### BRIEF DESCRIPTION OF DRAWINGS

This invention will be further described with reference to the accompanying drawings in which:

FIG. 1 is a cross-section schematic view of a heater in accordance with the present invention;

FIG. 2 is schematic view of a plurality of heaters of FIG. 1 shown in a bore hole of a geological formation;

FIG. 3 is an elevation schematic view of a fuel stack assembly of the heater of FIG. 1;

FIG. 4 is an elevation schematic view of a fuel cell of the fuel cell stack assembly of FIG. 3;

FIG. 5 is schematic view showing a first electrical connection arrangement of the heater in accordance with the present invention;

FIG. 6 is schematic view showing a second electrical connection arrangement of the heater in accordance with the present invention;

FIG. 7 is schematic view showing a third electrical connection arrangement of the heater in accordance with the present invention;

FIG. 8 is schematic view showing a fourth electrical connection arrangement of the heater in accordance with the present invention; and

FIG. 9 is schematic view showing a fifth electrical connection arrangement of the heater in accordance with the present invention.

### DETAILED DESCRIPTION OF INVENTION

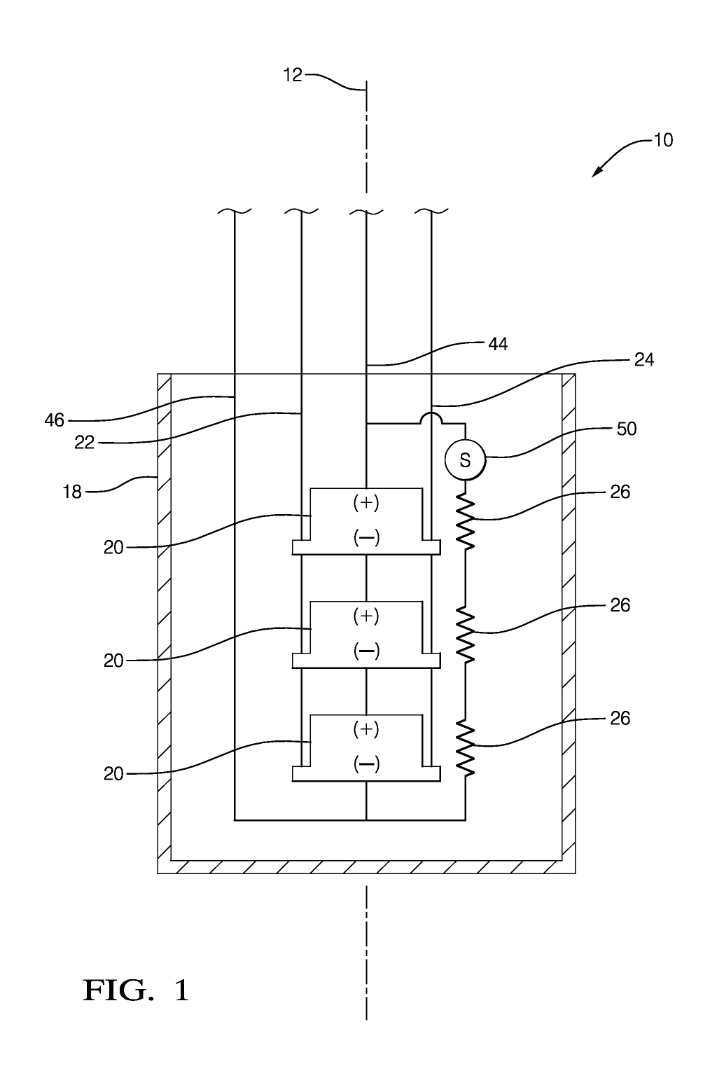

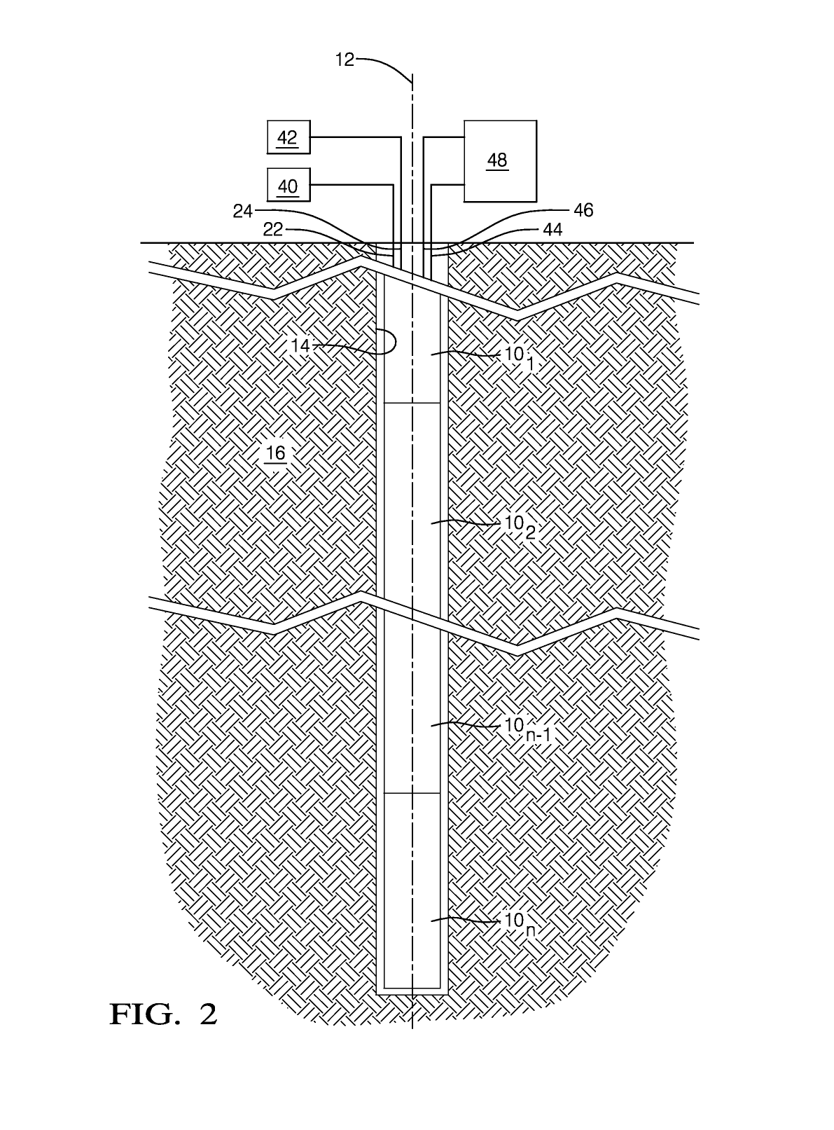

Referring now to FIGS. 1 and 2, a heater 10 extending along a heater axis 12 is shown in accordance with the present invention. A plurality of heaters 10₁, 10₂, . . . 10ₙ₋₁, 10ₙ, where n is the total number of heaters 10, may be connected together end to end within a bore hole 14 of a formation 16, for example, an oil containing geological formation, as shown in FIG. 2. Bore hole 14 may be only a few feet deep; however, may typically be several hundred feet deep to in excess of one thousand feet deep. Consequently, the number of heaters 10 needed may range from 1 to several hundred. It should be noted that the oil containing geological formation may begin as deep as one thousand feet below the surface and consequently, heater 10₁ may be located sufficiently deep within bore hole 14 to be positioned near the beginning of the oil containing geological formation. When this is the case, units without active heating components may be positioned from the surface to heater 10₁ in order to provide plumbing, power leads, and instrumentation leads to support and supply fuel and air to heaters 10₁ to 10ₙ, as will be discussed later.

Heater 10 generally includes a heater housing 18 extending along heater axis 12, a plurality of fuel cell stack assemblies 20 located within heater housing 18 such that each fuel cell stack assembly 20 is spaced axially apart from each other fuel cell stack assembly 20, a fuel supply conduit 22 for supplying fuel to fuel cell stack assemblies 20, an oxidizing agent supply conduit 24; hereinafter referred to as air supply conduit 24; for supplying an oxidizing agent, for example air, to fuel cell stack assemblies 20, and a plurality of electric resistive heating elements 26 for elevating the temperature of fuel cell stack assemblies 20 to operating temperature. While heater 10 is illustrated with three fuel cell stack assemblies 20 within heater housing 18, it should be understood that a lesser number or a greater number of fuel cell stack assemblies 20 may be included. The number of fuel cell stack assemblies 20 within heater housing 18 may be determined, for example only, by one or more of the following considerations: the length of heater housing 18, the heat output capacity of each fuel cell stack assembly 20, the desired density of fuel cell stack assemblies 20 (i.e. the number of fuel cell stack assemblies 20 per unit of length), and the desired heat output of heater 10. While heater 10 is illustrated with three electric resistive heating elements 26, it should be understood that a lesser number or a greater number of electric resistive heating elements 26 may be included and the number of electric resistive heating elements 26 may be the same or different than the number of fuel cell stack assemblies 20. The number of heaters 10 within bore hole 14 may be determined, for example only, by one or more of the following considerations: the depth of formation 16 which is desired to be heated, the location of oil within formation 16, and the length of each heater 10.

Heater housing 18 may be substantially cylindrical and hollow and may support fuel cell stack assemblies 20 within heater housing 18. Heater housing 18 of heater 10ₓ, where x is from 1 to n where n is the number of heaters 10 within bore hole 14, may support heaters 10ₓ₊₁ to 10ₙ by heaters 10ₓ₊₁ to 10ₙ hanging from heater 10ₓ. Consequently, heater housing 18 may be made of a material that is substantially strong to accommodate the weight of fuel cell stack assemblies 20 and heaters 10ₓ₊₁ to 10ₙ. The material of heater housing 18 may also have properties to withstand the elevated temperatures, for example 600° C. to 900° C., as a result of the operation of fuel cell stack assemblies 20. For example only, heater housing 18 may be made of a 300 series stainless steel with a wall thickness of 3/16 of an inch.

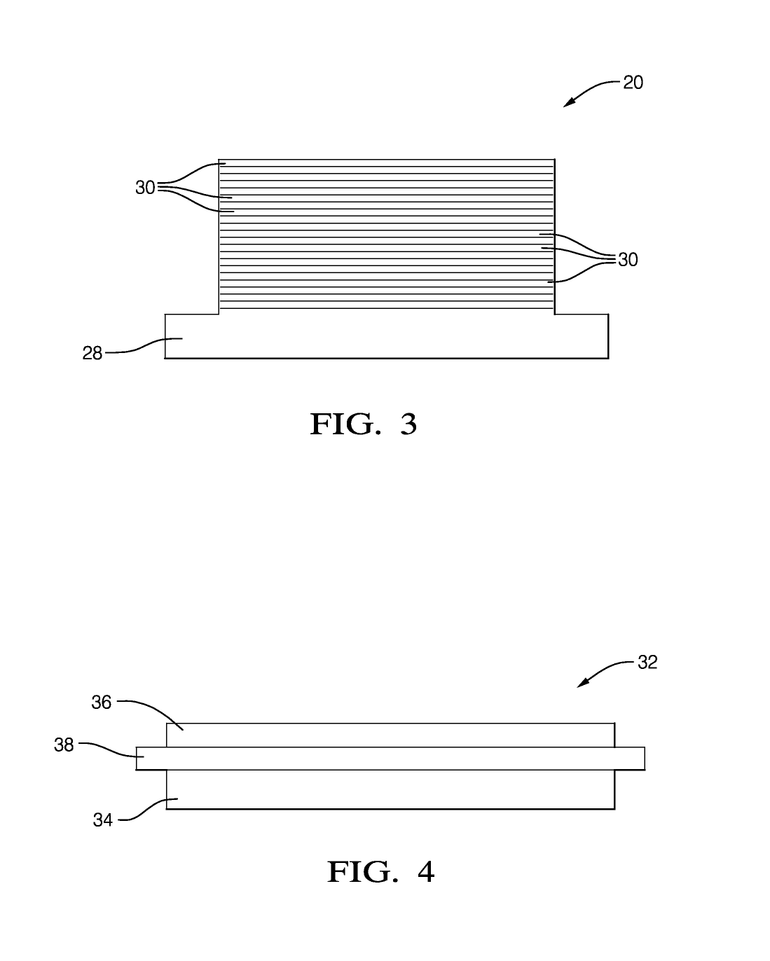

With continued reference to FIGS. 1 and 2 and now with additional reference to FIGS. 3 and 4, fuel cell stack assemblies 20 may be, for example only, solid oxide fuel cells which generally include a fuel cell manifold 28 and a plurality of fuel cell cassettes 30 (for clarity, only select fuel cell cassettes 30 have been labeled). Each fuel cell stack assembly 20 may include, for example only, 20 to 50 fuel cell cassettes 30.

Each fuel cell cassette 30 includes a fuel cell 32 having an anode 34 and a cathode 36 separated by a ceramic electrolyte 38. Each fuel cell 32 converts chemical energy from a fuel supplied to anode 34 into heat and electricity through a chemical reaction with air supplied to cathode 36. Fuel cell cassettes 30 have no electrochemical activity below a first temperature, for example, about 500° C., and consequently will not produce heat and electricity below the first temperature. Fuel cell cassettes 30 have a very limited electrochemical activity between the first temperature and a second temperature; for example, between about 500° C. and about 700° C., and consequently produces limited heat and electricity between the first temperature and the second temperature, for example only, about 0.01 kW to about 3.0 kW of heat (due to the fuel self-igniting above about 600° C.) and about 0.01 kW to about 0.5 kW electricity for a fuel cell stack assembly having thirty fuel cell cassettes 30. When fuel cell cassettes 30 are elevated above the second temperature, for example, about 700° C. which is considered to be the active temperature, fuel cell cassettes 30 are considered to be active and produce desired amounts of heat and electricity, for example only, about 0.5 kW to about 3.0 kW of heat and about 1.0 kW to about 1.5 kW electricity for a fuel cell stack assembly having thirty fuel cell cassettes 30. Further features of fuel cell cassettes 30 and fuel cells 32 are disclosed in United States Patent Application Publication No. US 2012/0094201 to Haltiner, Jr. et al. which is incorporated herein by reference in its entirety.

Fuel cell manifold 28 receives fuel, e.g. a hydrogen rich reformate, which may be supplied from a fuel reformer 40, through fuel supply conduit 22 and distributes the fuel to each fuel cell cassette 30. Fuel cell manifold 28 also receives an oxidizing agent, for example, air from an air supply 42, through air supply conduit 24 and distributes the air to each fuel cell cassette 30. Fuel cell manifold 28 also receives anode exhaust, i.e. spent fuel and excess fuel from fuel cells 32 which may comprise H₂, CO, H₂O, CO₂, and N₂, and cathode exhaust, i.e. spent air and excess air from fuel cells 32 which may comprise O₂ (depleted compared to the air supplied through air supply conduit 24) and N₂. The anode exhaust and cathode exhaust may be communicated from fuel cell manifold 28 to the top of bore hole 14 through respective anode and cathode exhaust conduits (not shown) or the anode and cathode exhaust may be communicated to a combustor (not shown) where the anode and cathode exhaust may be mixed and combusted in order to generate additional heat within heater housing 18.

Electric resistive heating elements 26 are disposed within heater housing 18 and arranged to elevate fuel cell stack assemblies 20 to the active temperature, which as mentioned previously is about 700° C. Each electric resistive heating element 26 may be positioned proximal to a respective fuel cell stack assembly 20 and may be, for example only, a resistance wire that is wrapped around a respective fuel cell stack assembly 20. Electric resistive heating elements 26 may be designed such that the voltage required to generate the desired heat does not exceed the electrochemical potential of fuel cell stack assemblies 20 to prevent damage to fuel cell stack assemblies 20 when electric resistive heating elements 26 are being used to elevate the temperature of fuel cell stack assemblies 20.

Heater 10 includes a positive conductor 44 and a negative conductor 46, thereby defining in part an electrical circuit for communicating electricity from an electricity distribution center 48 to electric resistive heating elements 26 and for communicating electricity generated by fuel cell stack assemblies 20 to electricity distribution center 48. Positive conductor 44 and negative conductor 46 may be located within heater housing 18 as shown. Electricity distribution center 48 may be located on the surface of formation 16 and may receive electricity from a utility grid (not shown), a power plant (not shown), or a generator (not shown) for communicating electricity to electric resistive heating elements 26. Electricity distribution center 48 may also communicate electricity to the utility grid from fuel cell stack assemblies 20 and/or to other electricity consuming devices.

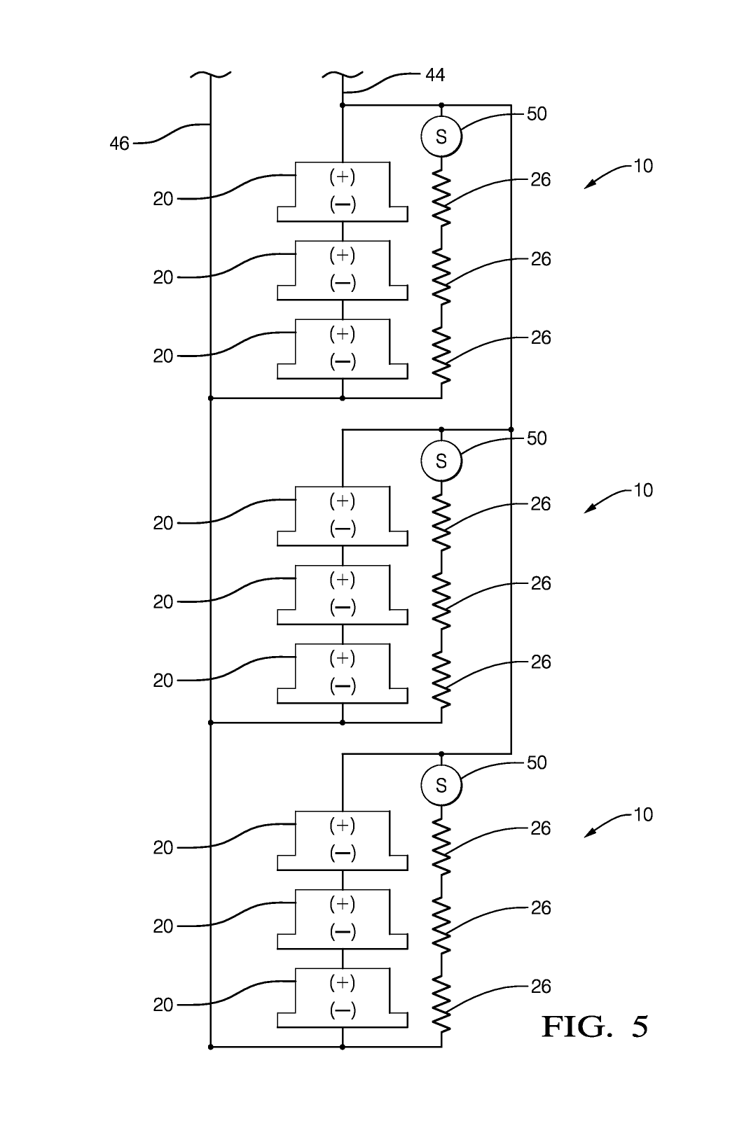

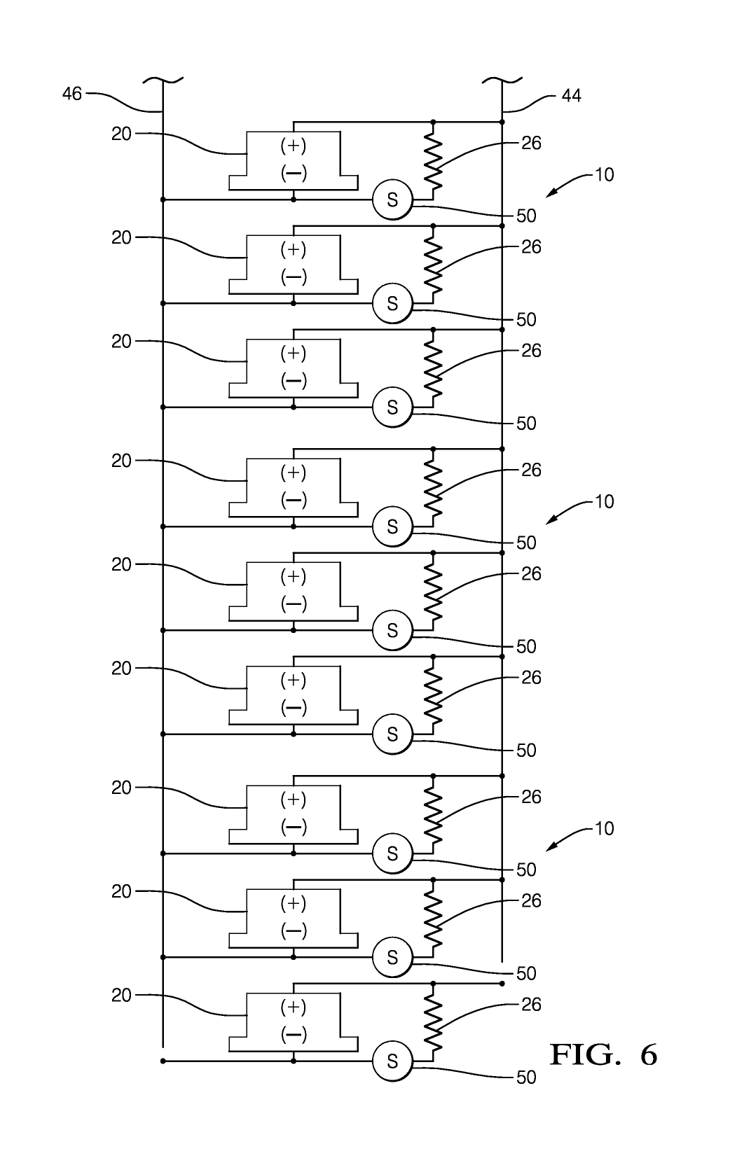

Reference will now be made to FIGS. 5-9 which each illustrate three heaters 10 connected together to illustrate various arrangements for electrically connecting fuel cell stack assemblies 20, electric resistive heating elements 26, and heaters 10. For clarity, heater housings 18, fuel supply conduit 22, and air supply conduit 24 have been omitted from FIGS. 5-9.

As shown in FIG. 5, fuel cell stack assemblies 20 of a respective heater 10 may be connected in series and the corresponding electric resistive heating elements 26 may be connected in series such that fuel cell stack assemblies 20 and electric resistive heating elements 26 are connected to positive conductor 44 and negative conductor 46; however, electric resistive heating elements 26 are connected in parallel with fuel cell stack assemblies 20. Also as shown in FIG. 5, heaters 10 are connected in parallel, thereby allowing the remaining heaters 10 to continue to operate if one heater 10 fails. A switch 50 may be provided in series with electric resistive heating elements 26 of each respective heater 10 in order to selectively inactivate electric resistive heating elements 26. Each switch 50 may be, for example only, a thermally activated switch arranged to open above a predetermined temperature, for example, a temperature indicative of the active temperature of fuel cell stack assemblies 20. In this way, electric resistive heating elements 26 may be turned off when fuel cell stack assemblies 20 are electrochemically active and generating electricity, thereby preventing electric resistive heating elements 26 from consuming electricity generated by fuel cell stack assemblies 20.

As shown in FIG. 6, fuel cell stack assemblies 20 of a respective heater 10 may be connected in parallel and each electric resistive heating element 26 may be connected in parallel with a respective fuel cell stack assembly 20 such that fuel cell stack assemblies 20 and electric resistive heating elements 26 are connected to positive conductor 44 and negative conductor 46. In this way any individual fuel cell stack assembly 20 may fail without affecting the remaining fuel cell stack assemblies 20 within heater 10 and individual electric resistive heating elements 26 may fail without affecting the remaining electric resistive heating elements 26. Also as shown in FIG. 6, heaters 10 are connected in parallel. Switch 50 may be provided in series with each electric resistive heating element 26 in order to selectively inactivate electric resistive heating elements 26.

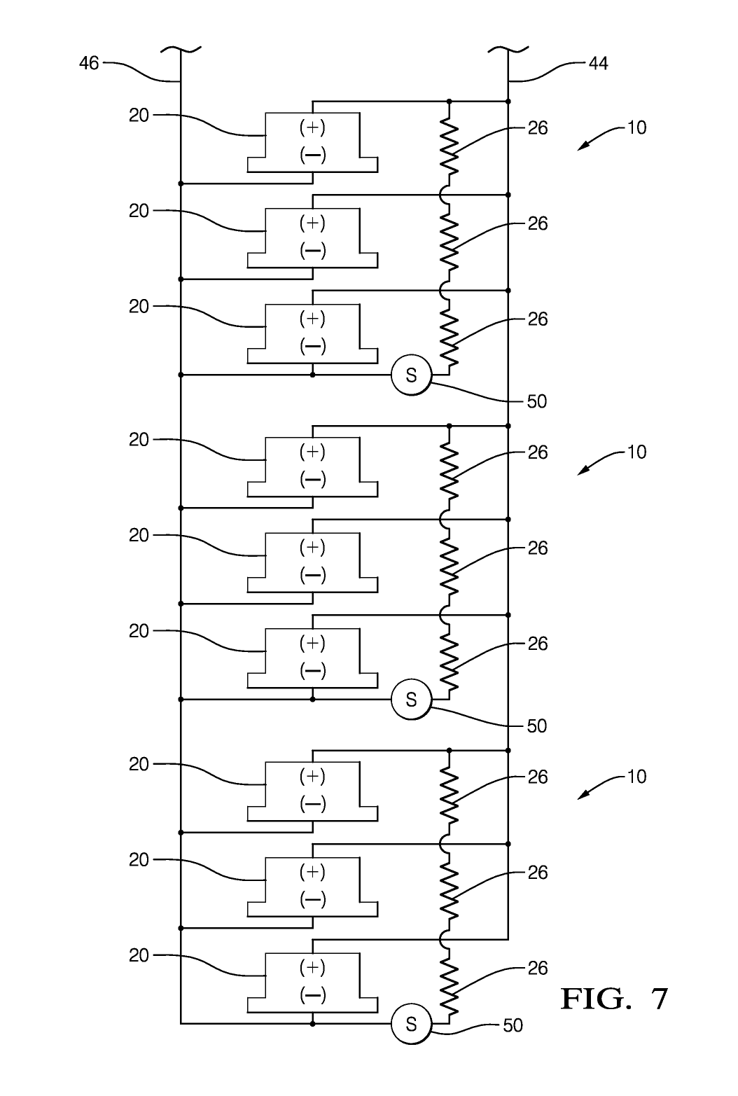

As shown in FIG. 7, fuel cell stack assemblies 20 of a respective heater 10 may be connected in parallel and the corresponding electric resistive heating elements 26 may be connected in series such that fuel cell stack assemblies 20 and electric resistive heating elements 26 are connected to positive conductor 44 and negative conductor 46 however; electric resistive heating elements 26 are connected in parallel with fuel cell stack assemblies 20. Also as shown in FIG. 7, heaters 10 are connected in parallel. Switch 50 may be provided in series with electric resistive heating elements 26 of a respective heater 10 in order to selectively inactivate electric resistive heating elements 26.

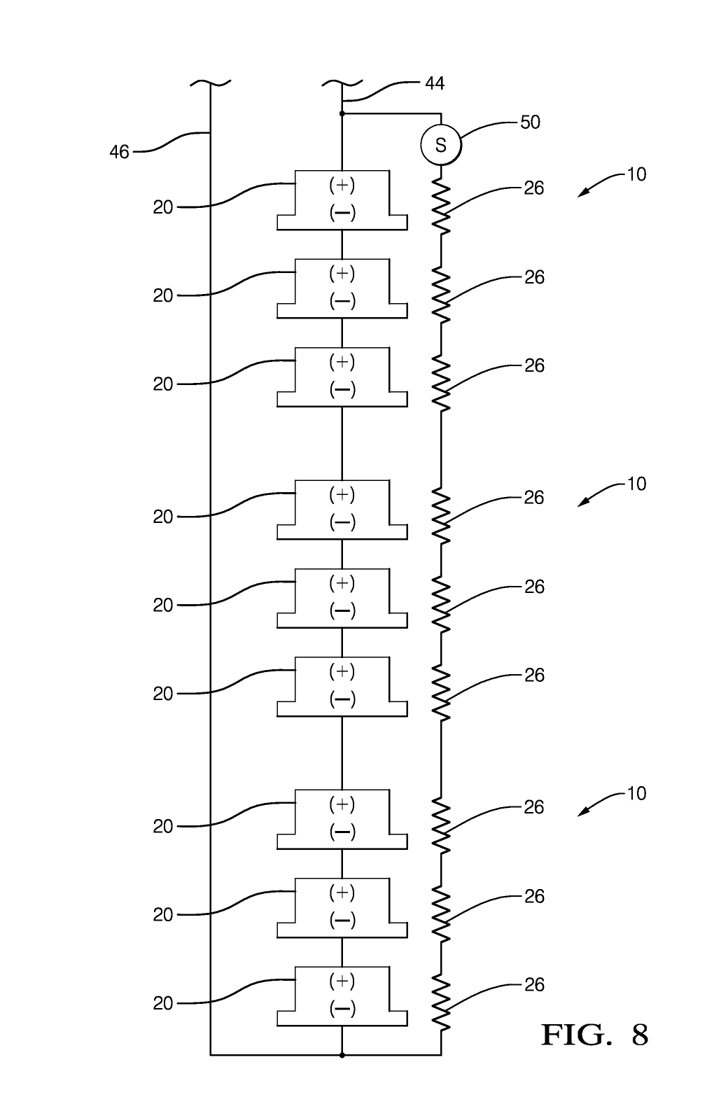

As shown in FIG. 8, fuel cell stack assemblies 20 of a respective heater 10 may be connected in series and the corresponding electric resistive heating elements 26 may be connected in series such that fuel cell stack assemblies 20 and electric resistive heating elements 26 are connected to positive conductor 44 and negative conductor 46. Also as shown in FIG. 8, heaters 10 are connected in series. Switch 50 may be provided in series with electric resistive heating elements 26 in order to selectively inactivate electric resistive heating elements 26.

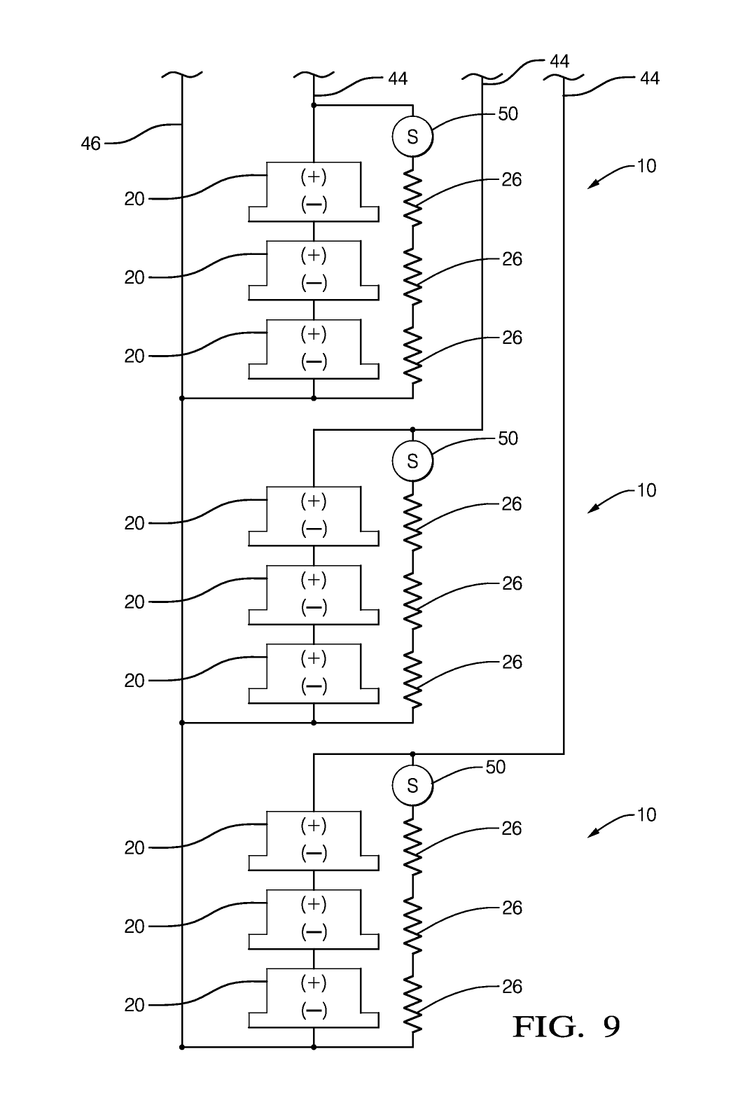

As shown in FIG. 9, a plurality of positive conductors 44 may be provided such that each positive conductor 44 is dedicated to a respective heater 10. While FIG. 9 illustrates that fuel cell stack assemblies 20 of a respective heater 10 are connected in series, it should be understood that fuel cell stack assemblies 20 may be connected in parallel as shown in FIG. 6. Similarly, while FIG. 9 illustrates that electric resistive heating elements 26 of each heater 10 connected in series, it should be understood that electric resistive heating elements 26 may be connected in parallel as shown in FIG. 5. Switch 50 may be provided in series with electric resistive heating elements 26 of a respective heater 10 in order to selectively inactivate electric resistive heating elements 26.

In operation, after heaters 10 are installed within bore hole 14, fuel cell stack assemblies 20 must be elevated to the active temperature of fuel cell stack assemblies 20 before fuel cell stack assemblies 20 may be used to generate heat and electricity. In order to elevate fuel cell stack assemblies 20 to the active temperature, electricity distribution center 48 may supply electricity to positive conductor 44. Since fuel cell stack assemblies 20 are not electrochemically active due to being below the active temperature, fuel cell stack assemblies 20 will be an open circuit, thereby preventing the electricity supplied to positive conductor 44 from passing through fuel cell stack assemblies 20. At the same time switch(es) 50 are closed and allow electricity to pass through electric resistive heating elements 26, thereby causing electric resistive heating elements 26 to heat up. The heat produced by electric resistive heating elements 26 may be transferred to fuel cell stack assemblies 20 through conduction, convection and/or radiation. After fuel cell stack assemblies 20 have reached a predetermined temperature, switch(es) 50 may open, thereby ceasing operation of electric resistive heating elements 26. After fuel cell stack assemblies 20 are electrochemically active and switch(es) 50 is/are open, electricity generated by fuel cell stack assemblies 20 may supply electricity to electricity distribution center 48 through positive conductor 44. In this way, the positive conductor 44 and negative conductor 46 may service both fuel cell stack assemblies 20 and electric resistive heating elements 26, thereby eliminating the need for separate conductors for fuel cell stack assemblies 20 and electric resistive heating elements 26.

While this invention has been described in terms of preferred embodiments thereof, it is not intended to be so limited, but rather only to the extent set forth in the claims that follow.

We claim:

1. A heater comprising:
a heater housing extending along a heater axis;
a fuel cell stack assembly disposed within said heater housing and having a plurality of fuel cells which convert chemical energy from a fuel into heat and electricity through a chemical reaction with an oxidizing agent;
an electric resistive heating element disposed within said heater housing;
a positive conductor disposed within said heater housing and connected to said fuel cell stack assembly and to said electric resistive heating element; and
a negative conductor connected to said fuel cell stack assembly and to said electric resistive heating element;
wherein said electric resistive heating element is arranged to elevate said fuel cell stack assembly from a first inactive temperature to a second active temperature.

2. A heater as in claim 1 wherein said electric resistive heating element is connected in parallel with said fuel cell stack assembly.

3. A heater as in claim 1 wherein said fuel cell stack assembly is one of a plurality of fuel cell stack assemblies disposed within said heater housing.

4. A heater as in claim 3 wherein:
said electric resistive heating element is one of a plurality of electric resistive heating elements disposed within said heater housing; and
said plurality of electric resistive heating elements is arranged to elevate said plurality of fuel cell stack assemblies from said first inactive temperature to said second active temperature.

5. A heater as in claim 4 wherein:
each said fuel cell stack assembly of said plurality of fuel cell stack assemblies are connected in series with every other said fuel cell stack assembly of said plurality of fuel cell stack assemblies;
each said electric resistive heating element of said plurality of electric resistive heating elements is connected in series with every other said electric resistive heating element of said plurality of electric resistive heating elements; and
said plurality of electric resistive heating elements is connected in parallel with said plurality of fuel cell stack assemblies.

6. A heater as in claim 1 further comprising a switch between said electric resistive heating element and one of said positive conductor and said negative conductor to selectively enable and disable said electric resistive heating element.

7. A heater as in claim 6 wherein said switch is a thermal fuse which is arranged to open at said second active temperature thereby disabling said electric resistive heating element and to close below said second active temperature thereby enabling said electric resistive heating element.

8. A heater as in claim 6 wherein said fuel cell stack assembly is one of a plurality of fuel cell stack assemblies disposed within said heater housing.

9. A heater as in claim 8 wherein:
said electric resistive heating element is one of a plurality of electric resistive heating elements disposed within said heater housing;
said plurality of electric resistive heating elements is arranged to elevate said plurality of fuel cell stack assemblies from said first inactive temperature to said second active temperature; and
said switch is positioned between said plurality of electric resistive heating elements and one of said positive conductor and said negative conductor to selectively enable and disable said plurality of electric resistive heating elements.

10. A heater as in claim 9 wherein:
each said fuel cell stack assembly of said plurality of fuel cell stack assemblies is connected in series with every other said fuel cell stack assembly of said plurality of fuel cell stack assemblies;
each said electric resistive heating element of said plurality of electric resistive heating elements is connected in series with every other said electric resistive heating element of said plurality of electric resistive heating elements; and
said plurality of electric resistive heating elements is connected in parallel with said plurality of fuel cell stack assemblies.

11. A heater as in claim 1 wherein said heater is disposed within a bore hole of an oil containing geological formation.

12. A plurality of heaters disposed within a bore hole of a formation, each said heater comprising:
a plurality of fuel cell stack assemblies disposed within said bore hole, each said fuel cell stack assembly having a plurality of fuel cells which convert chemical energy from a fuel into heat and electricity through a chemical reaction with an oxidizing agent;
an electric resistive heating element disposed within said bore hole;
a positive conductor disposed within said bore hole and connected to said plurality of fuel cell stack assemblies and to said electric resistive heating element; and
a negative conductor connected to said plurality of fuel cell stack assemblies and to said electric resistive heating element;
wherein said electric resistive heating element is arranged to elevate at least one of said plurality of fuel cell stack assemblies from a first inactive temperature to a second active temperature.

13. A plurality of heaters as in claim 12 wherein:
said plurality of fuel cell stack assemblies of each respective said heater are connected in series;
said electric resistive heating element of each respective said heater is connected in parallel with said plurality of fuel cell stack assemblies of each respective said heater; and
said plurality of fuel cell stack assemblies of adjacent said heaters are connected in parallel.

14. A plurality of heaters as in claim 13 wherein said electric resistive heating elements of adjacent said heaters are connected in parallel.

15. A plurality of heaters as in claim 14 wherein each said heater further comprises a switch between said electric resistive heating element and one of said positive conductor and said negative conductor to selectively enable and disable said electric resistive heating element.

16. A plurality of heaters as in claim 12 wherein:
said electric resistive heating element of each respective said heater is one of a plurality of electric resistive heating elements of each respective said heater;
said plurality of fuel cell stack assemblies of each respective said heater are connected in series;
each respective said electric resistive heating element is connected in parallel with a respective one of said plurality of fuel cell stack assemblies; and
said plurality of fuel cell stack assemblies of adjacent said heaters are connected in parallel.

17. A plurality of heaters as in claim 16 wherein each said heater further comprises a switch between each said electric resistive heating element and one of said positive conductor and said negative conductor to selectively enable and disable each said electric resistive heating element.

18. A plurality of heaters as in claim 12 wherein:
said electric resistive heating element of each respective said heater is one of a plurality of electric resistive heating elements of each respective said heater;
said plurality of fuel cell stack assemblies of each respective said heater are connected in parallel;
said plurality of electric resistive heating elements of each respective said heater are connected in series;
said plurality of electric resistive heating elements of each respective said heater are connected in parallel with said plurality of fuel cell stack assemblies;
said plurality of fuel cell stack assemblies of adjacent said heaters are connected in parallel; and
said plurality of electric resistive heating elements of adjacent said heaters are connected in parallel.

19. A plurality of heaters as in claim 18 wherein each said heater further comprises a switch between said plurality of electric resistive heating elements and one of said positive conductor and said negative conductor to selectively enable and disable said plurality of electric resistive heating elements.

20. A plurality of heaters as in claim 12 wherein:
said electric resistive heating element of each respective said heater is one of a plurality of electric resistive heating elements of each respective said heater;
said plurality of fuel cell stack assemblies of each respective said heater are connected in series;
said plurality of electric resistive heating elements of each respective said heater are connected in series;
said plurality of electric resistive heating elements of each respective said heater are connected in parallel with said plurality of fuel cell stack assemblies;
said plurality of fuel cell stack assemblies of adjacent said heaters are connected in series; and
said plurality of electric resistive heating elements of adjacent said heaters are connected in series.

21. A plurality of heaters as in claim 20 wherein said plurality of heaters comprises a switch between said plurality of electric resistive heating elements and one of said positive conductor and said negative conductor to selectively enable and disable said plurality of electric resistive heating elements of said plurality of heaters.

22. A method of operating a heater having 1) a heater housing extending along a heater axis; 2) a fuel cell stack assembly disposed within said heater housing and having a plurality of fuel cells which convert chemical energy from a fuel into heat and electricity through a chemical reaction with an oxidizing agent; 3) an electric resistive heating element disposed within said heater housing; 4) a positive conductor disposed within said heater housing and connected to said fuel cell stack assembly and to said electric resistive heating element; and 5) a negative conductor connected to said fuel cell stack assembly and to said electric resistive heating element; said method comprising:
supplying electricity to said electric resistive heating element from an electricity distribution center through said positive conductor when said fuel cell stack assembly is not electrochemically active;
using said electric resistive heating element to elevate the temperature of said fuel cell stack assembly.

23. A method as in claim 22 further comprising: supplying electricity from said fuel cell stack assembly to said electricity distribution center through said positive conductor when said fuel cell stack assembly is electrochemically active.

24. A method as in claim 23 wherein said heater further comprises a switch between said electric resistive heating element and one of said positive conductor and said method further comprises using said switch to disable said electric resistive heating element when said fuel cell stack assembly is electrochemically active.

25. A method as in claim 24 further comprising opening said switch based on a temperature indicative of said fuel cell stack assembly.
